(19) United States
(12) Patent Application Publication
(10) Pub. No.: US 2024/0415735 A1
(43) Pub. Date: Dec. 19, 2024

(54) Reversible Vibration Glove Device And Method

(71) Applicant: Allen Everett, Tampa, FL (US)

(72) Inventor: Allen Everett, Tampa, FL (US)

(21) Appl. No.: 18/210,334

(22) Filed: Jun. 15, 2023

(51) Int. Cl. A61H 37/00; A41D 19/00; A61H 23/02

(52) U.S. Cl. CPC A61H 37/00; A41D 19/0024; A61H 23/02; A41D 2400/322; A61H 2201/165; A61H 2201/169; A61H 2201/5005; A61H 2201/5025

(57) ABSTRACT

A reversible vibration glove device and method for massaging both the user and the masseur includes a pair of gloves being positioned on a respective one of a pair of hands of a masseur. Each of the gloves has a vibration surface where a vibration pad is integrated within. The vibration pad has path for emitting rapid oscillations of movement to produce a therapeutic motion. In addition, the path is positioned proximate to a plurality of apertures of each of the gloves. Furthermore, a battery compartment is positioned on a band of each of the gloves and houses a battery providing electric power to the path of the vibration pad. A button is in electric communication with the battery and is an actuator for the vibration pad.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vibration glove device and more particularly pertains to a new vibration glove device for massaging both the user and the masseur.

### (2) Description of Related Art Including Information Disclosed Under 37 CFR 1.97 and 1.98

The prior art relates to vibration glove devices. The prior art includes a variety of vibration glove devices configured for being supplementary in providing a massage for a user. Known prior art lacks a vibration glove device configured for being reversible wherein providing a massage for the user and for the fingers of the hand of the masseur.

### BRIEF SUMMARY OF THE INVENTION

An embodiment of the disclosure meets the needs presented above by generally comprising a pair of gloves being configured for being positioned on a respective one of a pair of hands of a masseur. Each of the gloves has a vibration surface, a plain surface, and a plurality of apertures. Additionally, each of the gloves has an opening including a band. A vibration pad is integrated within the vibration surface of each of the gloves. The vibration pad has path being configured for emitting rapid oscillations of movement to produce a therapeutic motion. In addition, the path is positioned proximate to the plurality of apertures of each of the gloves. Furthermore, a battery compartment is positioned on the band of each of the gloves and houses a battery being configured for providing electric power to the path of the vibration pad. A button is in electric communication with the battery and is an actuator for the vibration pad.

Another embodiment of the disclosure includes a method comprising a step of inserting a pair of hands of a masseur through a respective one of an opening of a pair of gloves and nesting a plurality of fingers of each of the hands through a respective one of a plurality of apertures of each of the gloves. The masseur pushes a button to actuate a vibration pad of each of the gloves prior to pushing the button a plurality of times to engage a variety of pulses of vibration. The masseur massages a user using the plurality of fingers each of the hands with each of the gloves providing vibration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a reversible vibration glove device and method according to an embodiment of the disclosure.

FIG. 2 is a rear view of an embodiment of the disclosure.

FIG. 3 is a cross-sectional view of an embodiment of the disclosure taken from FIG. 1 of Line 3-3.

FIG. 4 is an in-use view of an embodiment of the disclosure.

FIG. 5 is a block diagram view of an embodiment of the disclosure.

### DETAILED DESCRIPTION OF THE INVENTION

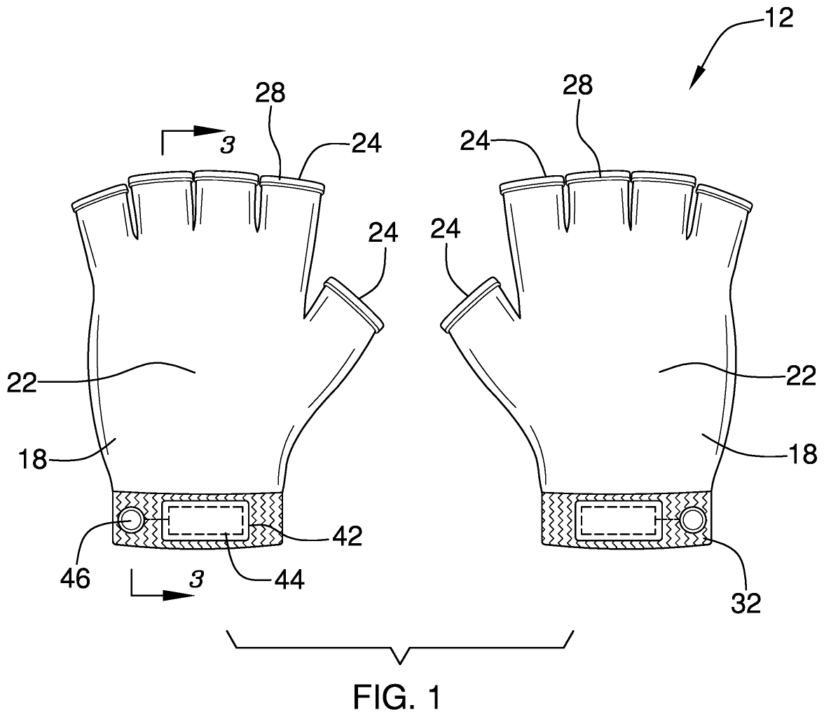

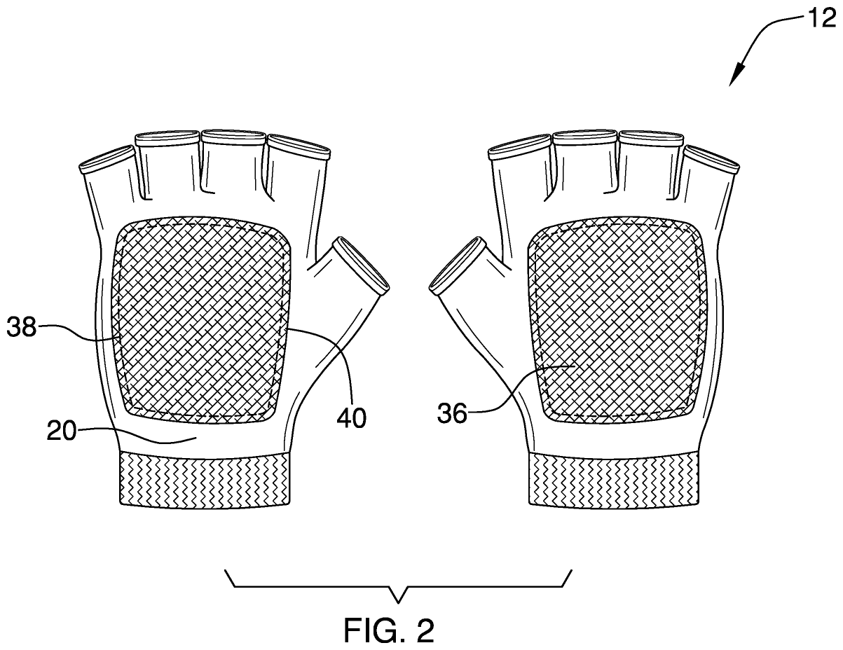

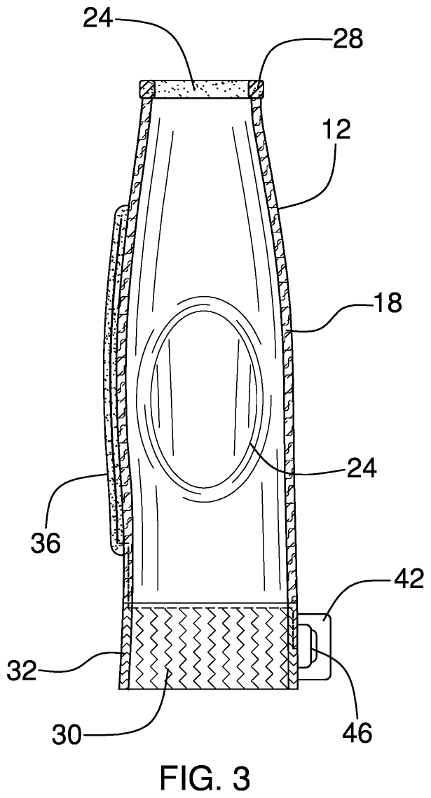

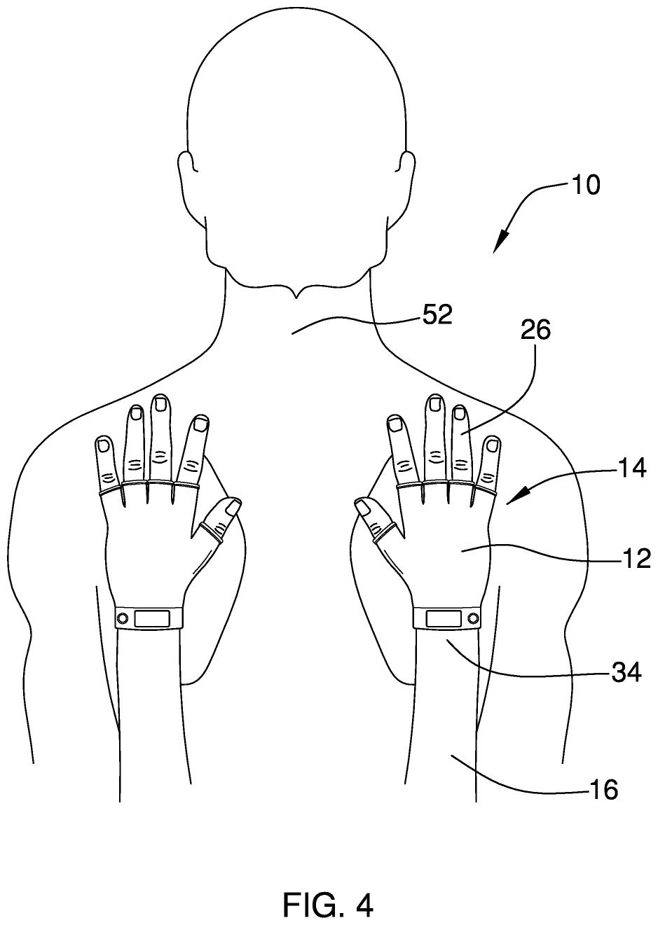

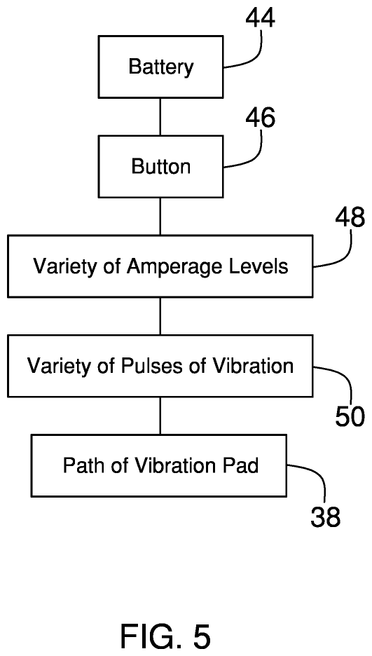

With reference now to the drawings, and in particular to FIGS. 1 through 5 thereof, a new vibration glove device embodying the principles and concepts of an embodiment of the disclosure and generally designated by the reference numeral 10 will be described.

As best illustrated in FIGS. 1 through 5, the reversible vibration glove device and method 10 generally comprises a pair of gloves 12 being configured for being worn on a respective one of a pair of hands 14 of a masseur 16. Each of the gloves 12 is a mesh material 18 being configured for being supple and breathable wherein each of the gloves 12 does not produce moisture on each of the hands 14. Each of the gloves 12 has a vibration surface 20, a plain surface 22, and a plurality of apertures 24 wherein each of the apertures 24 is configured for inserting a respective one of a plurality of fingers 26 of the masseur 16. Each of the apertures 24 is a plastic material 28 is configured for being elastic wherein each of the apertures 24 expands to fit each of the fingers 26. Each of the gloves 12 has an opening 30 including a band 32 configured for enwrapping a wrist 34 of the masseur 16. The band 32 is elastic wherein expanding to fit the wrist 34 of the masseur 16.

A vibration pad 36 is integrated within of the vibration surface 20 of each of the gloves 12. The vibration pad 36 has path 38 being a wire configured for emitting rapid oscillations of movement to produce a therapeutic motion. The path 38 is positioned on a perimeter edge 40 of the vibration pad 36 wherein the path 38 is positioned proximate to the plurality of apertures 24 of each of the gloves 12. The path 38 of the vibration pad 36 is configured for vibrating the vibration pad 36 and the plurality of apertures 24.

A battery compartment 42 is positioned on the band 32 of each of the gloves 12. The battery compartment 42 houses a battery 44 being in electric communication with the vibration pad 36. The battery 42 is configured for providing electric power to the path 38 of the vibration pad 36. Furthermore, a button 46 is in electric communication with the battery. 44 The button 46 is positioned on the band 32 of each of the gloves 12 proximate to the battery compartment 42. The button 44 is an actuator being a three way push button configured for supplying a variety of amperage levels 48 wherein providing a variety of pulses of vibration 50 to the path of the vibration pad. The variety of pulses of vibration 50 includes three different alternatives.

In use, the pair of hands 14 of the masseur 16 is inserted through a respective one of the opening 30 of the pair of gloves 12. The vibration surface 20 of each of the gloves 12 can be worn on either the palm of each of the hands 14 or the back of each of the hands 14. The plurality of fingers 26 of each of the hands 14 of the masseur 16 nests through a respective one of the plurality of apertures 24 of each of the gloves 12. The masseur 16 pushes the button 46 to actuate the vibration pad 36 of each of the gloves 12 prior to pushing the button 46 a plurality of times to engage the variety of pulses of vibration 50. The masseur 16 massages a user 52 using the plurality of fingers 26 each of the hands 14 with each of the gloves 12 providing vibration.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reversible vibration glove device configured for emitting a variety of vibration pulses where in ameliorating in massaging a user, the reversible vibration glove device comprising:
a pair of gloves configured for being positioned on a respective one of a pair of hands of a masseur, each of the gloves having a vibration surface and a plain surface, each of the gloves having a plurality of apertures, each of the gloves having an opening, the opening having a band;
a vibration pad being integrated within of the vibration surface of each of the gloves, the vibration pad having path, the path of the vibration pad being configured for emitting rapid oscillations of movement to produce a therapeutic motion, the path being positioned proximate to the plurality of apertures of each of the gloves
a battery compartment being positioned on the band of each of the gloves, the battery compartment housing a battery, the battery being configured for providing electric power to the path of the vibration pad; and
a button being in electric communication with the battery, the button being an actuator for the vibration pad.

2. The reversible vibration glove device of claim 1, further comprising each of the gloves being a mesh material, the mesh material being configured for being supple and breathable.

3. The reversible vibration glove device of claim 1, further comprising each of the apertures being configured for inserting a respective one of a plurality of fingers of the masseur.

4. The reversible vibration glove device of claim 3, further comprising each of the apertures being a plastic material, the plastic material being configured for being elastic.

5. The reversible vibration glove device of claim 3, further comprising the band of the opening being configured for enwrapping a wrist of the masseur.

6. The reversible vibration glove device of claim 1, further comprising the path being a wire.

7. The reversible vibration glove device of claim 6, further comprising the path being positioned on a perimeter edge of the vibration pad.

8. The reversible vibration glove device of claim 1, further comprising the battery being in electric communication with the vibration pad.

9. The reversible vibration glove device of claim 5, further comprising the button being positioned on the band of each of the gloves.

10. The reversible vibration glove device of claim 9, further comprising the button being a three way push button configured for supplying a variety of amperage levels wherein providing a variety of pulses of vibration to the path of the vibration pad.

11. A reversible vibration glove device configured for emitting a variety of vibration pulses where in ameliorating in massaging a user, the reversible vibration glove device comprising:
A pair of gloves configured for being positioned on a respective one of a pair of hands of a masseur, each of the gloves being a mesh material, the mesh material being configured for being supple and breathable, each of the gloves having a vibration surface and a plain surface, each of the gloves having a plurality of apertures, each of the apertures being configured for inserting a respective one of a plurality of fingers of the masseur, each of the apertures being a plastic material, the plastic material being configured for being elastic, each of the gloves having an opening, the opening having a band, the band of the opening being configured for enwrapping a wrist of the masseur;
a vibration pad being integrated within of the vibration surface of each of the gloves, the vibration pad having path, the path being a wire, the path of the vibration pad being configured for emitting rapid oscillations of movement to produce a therapeutic motion, the path being positioned on a perimeter edge of the vibration pad, the path being positioned proximate to the plurality of apertures of each of the gloves;
a battery compartment being positioned on the band of each of the gloves, the battery compartment housing a battery, the battery being in electric communication with the vibration pad, the battery being configured for providing electric power to the path of the vibration pad; and
a button being in electric communication with the battery, the button being positioned on the band of each of the gloves, the button being an actuator for the vibration pad, the button being a three way push button configured for supplying a variety of amperage levels wherein providing a variety of pulses of vibration to the path of the vibration pad.

12. A method for ameliorating a massage using a reversible vibration glove device, the method comprising a step of:
inserting a pair of hands of a masseur through respective one of an opening of a pair of gloves;
nesting a plurality of fingers of each of the hands through a respective one of a plurality of apertures of each of the gloves;
pushing a button to actuate a vibration pad of each of the gloves;
pushing the button a plurality of times to engage a variety of pulses of vibration; and
massaging a user using the plurality of fingers of each of the hands with each of the gloves providing vibration.
